(19) United States
(12) Patent Application Publication
(10) Pub. No.: US 2009/0160330 A1
(43) Pub. Date: Jun. 25, 2009

(54) SOLID-STATE ILLUMINATING APPARATUS

(75) Inventors: CHIH-PENG HSU, Chu-Nan (TW); CHUN-WEI WANG, Chu-Nan (TW)

Correspondence Address: PCE INDUSTRY, INC.;ATT. Steven Reiss, 458 E. LAMBERT ROAD, FULLERTON, CA, 92835, US

(73) Assignee: FOXSEMICON INTEGRATED TECHNOLOGY, INC., Chu-Nan (TW)

(21) Appl. No.: 12/242,565

(22) Filed: Sep. 30, 2008

(30) Foreign Application Priority Data
Dec. 19, 2007 (CN) 200710203253.9

(51) Int. Cl. H01J 1/62

(52) U.S. Cl. 313/506; 313/498

(57) ABSTRACT

A solid-state illuminating apparatus for emitting white light with high CRI includes a substrate, a first lighting element, a second lighting element, a third lighting element. The first, second and third lighting elements are respectively placed in a first, a second, and a third receiving groove. The first lighting element includes a first solid-state lighting chip and a first filling layer encapsulating the first solid-state lighting chip therein. Similar to the first lighting element, the second lighting element includes a second solid-state lighting chip and a second filling layer, and the third lighting element includes a third solid-state lighting chip and a third filling layer. The first, second and third solid-state lighting chip are solid-state lighting chip with the same color light. At least two of the first, second, and third filling layer include two different phosphor materials respectively doped therein.

### CROSS-REFERENCE TO RELATED APPLICATIONS

This application claims all benefits accruing under 35 U.S.C. §119 from China Patent Application No. 200710203253.9, filed on Dec. 19, 2007 in the China Intellectual Property Office, the disclosures of which are incorporated herein by reference.

### BACKGROUND

1. Technical Field

The present invention generally relates to solid-state illuminating apparatuses, and particularly to a light emitting diode illuminating apparatus having improved color temperature stability of the emitting light.

2. Description of Related Art

Light emitting diodes (LEDs) as solid-state illuminating apparatuses are widely used in the illumination field to substitute for the conventional fluorescent lamp due to their high brightness, long service lifetime, and wide color gamut. Relevant subject is disclosed in an article entitled “Solid-State Lighting: Toward Superior Illumination”, published in Proceedings of the IEEE, Vol. 93, No. 10, by Michael S. Shur et al. in October, 2005, the disclosure of which is incorporated herein by reference.

Generally, the LED as a lighting source, needs high color rendering index (CRI), such as CRI>90. A conventional LED with the high CRI includes a blue LED chip, a red LED chip, and an encapsulant encapsulating the blue LED chip and the red LED chip therein. The encapsulant has a yellow phosphor material doped therein.

The blue LED chip and the red LED chip are different type LED chips, that is, the blue LED chip is a GaN LED chip and the red LED chip is an AlGaInP LED chip. Thus, when the temperatures of the blue LED chip and the red LED chip rises, the light attenuation of the blue LED chip is different from that of the red LED chip. Generally, the light attenuation of the red LED chip is large than that of the blue LED chip, so that the color temperature of white light emitted from the LED is always blue shift and the stability of the color temperature is not good enough.

What is needed, therefore, is a solid-state illuminating apparatus having improved color temperature stability of the emitting light, which can overcome the above-mentioned disadvantages.

### SUMMARY

The present invention relates to a solid-state illuminating apparatus. According to an exemplary embodiment of the present invention, the solid-state illuminating apparatus includes a substrate, the substrate has a first receiving groove, a second receiving groove and a third receiving groove, the first, second and third receiving grooves are parallel with each other. A first lighting element placed in the first receiving groove, a second lighting element placed in the second receiving groove, and a third lighting element placed in the third receiving groove. The first lighting element includes a first solid-state lighting chip and a first filling layer encapsulating the first solid-state lighting chip in the first receiving groove. The second lighting element includes a second solid-state lighting chip and a second filling layer encapsulating the second solid-state lighting chip in the second receiving groove. The third lighting element includes a third solid-state lighting chip and a third filling layer encapsulating the third solid-state lighting chip in the third receiving groove. The first, second and third solid-state lighting chips are solid-state lighting chips with the same color light. At least two of the first filling layer, the second filling layer, and the third filling layer include two different phosphor materials respectively doped therein. Thus, light emitting from the first filling layer, the second filling layer, and the third filling layer is mixed and appearing to be white light.

Other advantages and novel features will become more apparent from the following detailed description of the present invention, when taken in conjunction with the accompanying drawings.

### BRIEF DESCRIPTION OF THE DRAWINGS

Many aspects of the present apparatus can be better understood with reference to the following drawings. The components in the drawings are not necessarily drawn to scale, the emphasis instead being placed upon clearly illustrating the principles of the present apparatus. Moreover, in the drawings, like reference numerals designate corresponding parts throughout the several views.

FIG. 1 is a cross-sectional view of the solid-state illuminating apparatus of a first exemplary embodiment of the present invention.

FIG. 2 is a cross-sectional view of the solid-state illuminating apparatus of a second exemplary embodiment of the present invention.

FIG. 3 is a cross-sectional view of the solid-state illuminating apparatus that included an optical microstructure layer of a third exemplary embodiment of the present invention.

FIG. 4 is a partly cross-sectional view of the optical microstructure layer in FIG. 3.

FIG. 5 is a partly cross-sectional view of the optical microstructure layer has cone-shaped protrusions in FIG. 3.

### DETAILED DESCRIPTION

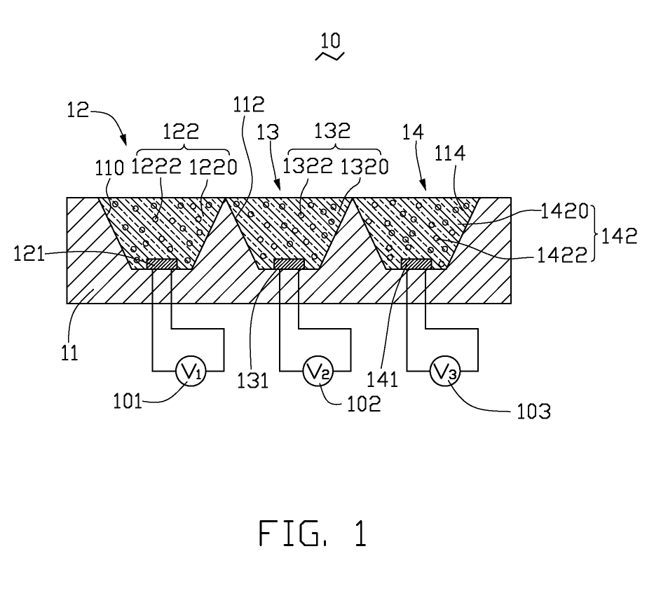

Referring to FIG. 1, a solid-state illuminating apparatus 10 in accordance with a first exemplary embodiment of the present invention includes a substrate 11, a first lighting element 12, a second lighting element 13, and a third lighting element 14.

The substrate 11 has a first receiving groove 110, a second receiving groove 112, and a third receiving groove 114, they are parallel with each other. The first lighting element 12, the second lighting element 13, and the third lighting element 14 are respectively mounted in the first receiving groove 110, the second receiving groove 112, and the third receiving groove 114. The first receiving groove 110, the second receiving groove 112, and the third receiving groove 114, each is shaped as a truncated cone with a diameter gradually decreases from a top portion towards a bottom portion.

The substrate 11 may be made of metal, ceramic material, or silicon. The metal can be copper or aluminium, and the ceramic material can be silicon nitride, alundum, or beryllium oxide. The substrate 11 is a circuit board which may be connected with a power source (not shown) to supply electric current to the first lighting element 12, the second lighting element 13, and the third lighting element 14. In addition, heat generated from the first lighting element 12, the second lighting element 13, and the third lighting element 14 can be dispersed out of the solid-state illuminating apparatus 10 through the substrate 11.

The first lighting element 12 includes a first solid-state lighting chip 121 and a first filling layer 122 encapsulating the first solid-state lighting chip 121 in the first receiving groove 110. The second lighting element 13 includes a second solid-state lighting chip 131 and a second filling layer 132 encapsulating the second solid-state lighting chip 131 in the second receiving groove 112. The third lighting element 14 includes a third solid-state lighting chip 141 and a third filling layer 142 encapsulating the third solid-state lighting chip 141 in the third receiving groove 114. The first solid-state lighting chip 121, the second solid-state lighting chip 131, and the third solid-state lighting chip 141 are respectively placed on the bottoms of the first receiving groove 110, the second receiving groove 112, and the third receiving groove 114. In the exemplary embodiment, the first solid-state lighting chip 121, the second solid-state lighting chip 131, and the third solid-state lighting chip 141 are light emitting diodes (LED) and electrically connected with the substrate 11.

The first solid-state lighting chip 121, the second solid-state lighting chip 131, and the third solid-state lighting chip 141 are solid-state lighting chips with the same color light, such as GaN LED chip or AlGaN LED chip. Thus, light attenuation of the first solid-state lighting chip 121 is essentially the same as that of the second solid-state lighting chip 131 and the third solid-state lighting chip 141. As a result, color temperature of white light emitted from the solid-state illuminating apparatus 10 is stable, and luminous efficiency of the solid-state lighting chips 121, 131, 141 are also stable.

In the exemplary embodiment, the first, second and third solid-state lighting chips 121, 131, and 141 are configured for emitting ultraviolet (UV) light, and they are electrically connected to a first power supply 101, a second power supply 102, and a third power supply 103, respectively. The first, second and third solid-state lighting chips 121, 131, and 141 each includes a separate driving circuit, that is, voltages and currents in the first, second and third solid-state lighting chips 121, 131, and 141 are independently controlled by the first power supply 101, the second power supply 102, and the third power supply 103, respectively.

The first filling layer 122 includes a first transparent material 1220 and a first phosphor 1222 evenly doped in the first transparent material 1220. The first transparent material 1220 may be silicone, resin, or the other light-pervious material. In the exemplary embodiment, the first transparent material 1220 comprises silicone with a refractive index larger than 1.4. The first phosphor 1222 is red phosphor, and can be excited by UV light generated from the first solid-state lighting chip 121 to emit red light. A center wavelength of the red light is in a range from 610 nm to 645 nm. The red phosphor can be made of nitride, silicate, oxide, or sulfide.

The second filling layer 132 may include a second transparent material 1320 and a second phosphor 1322 evenly doped in the second transparent material 1320. The second transparent material 1320 may be silicone, resin, or the other light-pervious materials. The second phosphor 1322 is green phosphor, and can be excited by UV light generated from the second solid-state lighting chip 131 to emit green light. A center wavelength of the green light is in a range from 505 nm to 540 nm. The green phosphor can be made of nitride, silicate, or oxide. In addition, the second phosphor 1322 may be yellow phosphor, and can be excited by UV light generated from the second solid-state lighting chip 131 to emit yellow light which has a center wavelength ranges from 550 nm to 600 nm.

The third filling layer 142 may include a third transparent material 1420 and a third phosphor 1422 evenly doped in the third transparent material 1420. The third transparent material 1420 may be silicone, resin, or the other light-pervious materials. The third phosphor 1422 is blue phosphor, and can be excited by UV light generated from the third solid-state lighting chip 141 to emit blue light. A center wavelength of the blue light is in a range from 445 nm to 475 nm. The blue phosphor can be made of nitride, silicate, or oxide.

In the exemplary embodiment, the first solid-state lighting chip 121, the second solid-state lighting chip 131, and the third solid-state lighting chip 141 can emit UV light when the same voltages are applied thereto by the first power supply 101, the second power supply 102, and the third power supply 103, respectively. The currents flowing through the first solid-state lighting chip 121, the second solid-state lighting chip 131, and the third solid-state lighting chip 141 are controlled by the first power supply 101, the second power supply 102, and the third power supply 103, respectively, to adjust color temperature of the red light, the green or yellow light, and the blue light respectively from the first filling layer 122, the second filling layer 132, and the third filling layer 142. Thus, white light formed by the mixture of red light, the green and the blue light, or the mixture of red light, the yellow light and the blue, has a high CRI to meet different needs.

Furthermore, the full width & half max (FWHM) of a combination of the UV LED chip and the phosphor is larger than that of a combination structured by various kinds of single color LED chip (e.g. a combination of red LED chip, green LED chip and blue LED chip), thus CRI of light emitted from the combination of the UV LED chip and the phosphor is better. For example, a FWHM of red LED is approximately 20 nm, but a FWHM of the combination of the UV LED chip and the red phosphor can reach at least 45 nm.

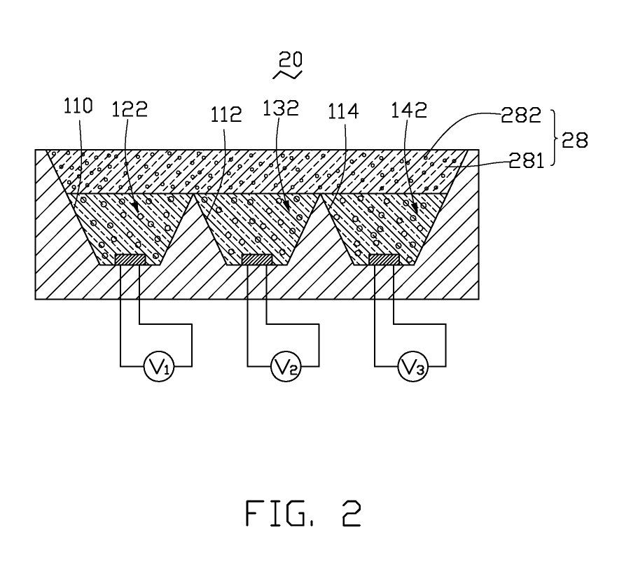

Referring to FIG. 2, a solid-state illuminating apparatus 20, in accordance with a second embodiment, is provided. The solid-state illuminating apparatus 20 of the exemplary second embodiment is similar to that of the first embodiment, except that the present solid-state illuminating apparatus 20 further includes a light scattering layer 28. The light scattering layer 28 covers the first receiving groove 110, the second receiving groove 112, and the third receiving groove 114.

The light scattering layer 28 includes a fourth transparent material 281 and a plurality of scattering particles 282 evenly distributed in the fourth transparent material 281. The fourth transparent material 281 may be silicone, resin, or the other light-pervious materials, and the refractive index of the fourth transparent material 281 is less than or equal to that of the transparent materials 1220, 1320, 1420. The scattering particles 282 can be made of TiO₂, plastic, PMMA, fused silica, Al₂O₃, MgO, sialon, or the other transparent nitrogen oxides. The scattering particles 282 is configured for scattering the red light, the green or yellow light, and the blue light respectively from the first filling layer 122, the second filling layer 132, and the third filling layer 142, so as to improve light uniformity of the solid-state illuminating apparatus 20.

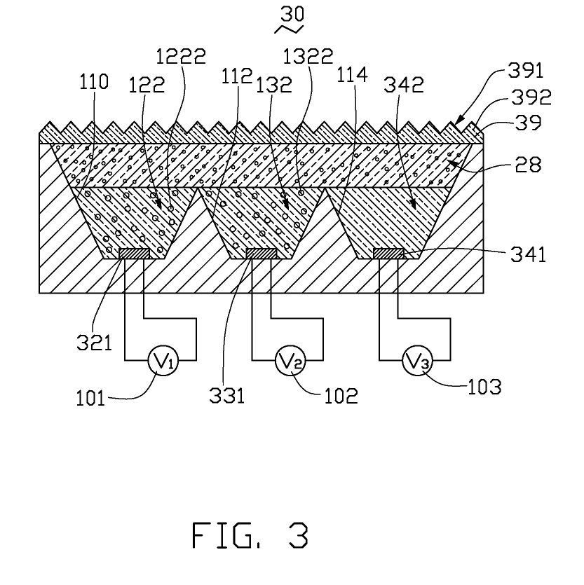

Referring to FIG. 3, a solid-state illuminating apparatus 30, in accordance with a third embodiment, is provided. The solid-state illuminating apparatus 30 of the exemplary third embodiment is similar to that of the second embodiment, except that the first solid-state lighting chip 321, the second solid-state lighting chip 331, and the third solid-state lighting chip 341 are blue LED chips, and they are used to emit blue light of which the center wavelength is in a range from 450 nm to 470 nm.

The third filling layer 342 is composed of the third transparent material.

The present solid-state illuminating apparatus 30 further includes an optical microstructure layer 39 arranged on one side of the light-scattering layer 28 facing away from the first receiving groove 110, the second receiving groove 112, and the third receiving groove 114.

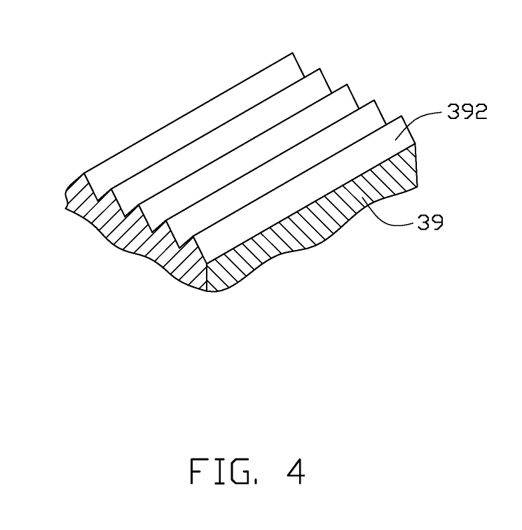

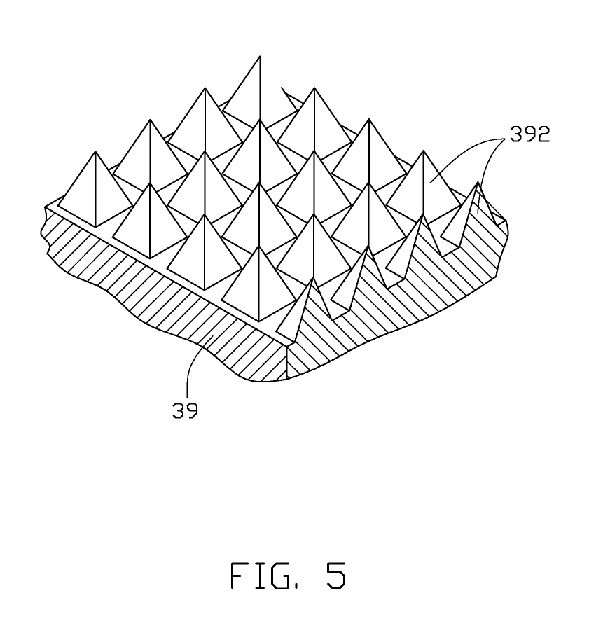

The optical microstructure layer 39 has a light emitting surface 391 away from the light-scattering layer 28, and the light emitting surface 391 has a plurality of optical microstructures 392 thereon. Referring to FIG. 4, the optical microstructures 392 are elongated parallel prisms. Referring to FIG. 5, the optical microstructures 392 are cone-shaped protrusions arranged in an array with their tips pointing away from the light-scattering layer 28. The optical microstructures 392 can be made of PMMA, plastic, or transparent glass. The optical microstructures 392 are used to mix light emitted through the light emitting surface 391 to change the light field pattern of the solid-state illuminating apparatus 30.

It can be understood that there may be no need to placed the light-scattering layer 28 between the optical microstructure layer 39 and the receiving groove 110, 112, 114. Air or other gases can be filled between the optical microstructure layer 39 and the receiving groove 110, 112, and 114. The optical microstructure layer 39 may also be applied in the solid-state illuminating apparatus 10 of the first embodiment.

In the present embodiment, the first solid-state lighting chip 321, the second solid-state lighting chip 331, and the third solid-state lighting chip 341 can emit blue light when the same voltages are applied thereto by the first power supply 101, the second power supply 102, and the third power supply 103, respectively. The first phosphor 1222 doped in the first filling layer 122 is excited by the blue light generated from the first solid-state lighting chip 321 to emit red light. The second phosphor 1322 doped in the second filling layer 132 is excited by the blue light generated from the second solid-state lighting chip 331 to emit green light or yellow light. The blue light generated from the third solid-state lighting chip 341 can emit out of the third filling layer 342. The currents flowing through the first solid-state lighting chip 321, the second solid-state lighting chip 331, and the third solid-state lighting chip 341 are controlled independently by the first power supply 101, the second power supply 102, and the third power supply 103, respectively, to adjust color temperature of the red light, the green or yellow light, and the blue light respectively from the first filling layer 122, the second filling layer 132, and the third filling layer 342. Thus, white light formed by the mixture of red light, the green and the blue light, or the mixture of red light, the yellow light and the blue, has a high CRI to meet different needs.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A solid-state illuminating apparatus comprising:
a substrate, the substrate having a first receiving groove, a second receiving groove and a third receiving groove, the first, second and third receiving grooves being parallel with each other;
a first lighting element placed in the first receiving groove, the first lighting element comprising a first solid-state lighting chip and a first filling layer encapsulating the first solid-state lighting chip in the first receiving groove;
a second lighting element placed in the second receiving groove, the second lighting element comprising a second solid-state lighting chip and a second filling layer encapsulating the second solid-state lighting chip in the second receiving groove;
a third lighting element placed in the third receiving groove, the third lighting element comprising a third solid-state lighting chip and a third filling layer encapsulating the third solid-state lighting chip in the third receiving groove;
wherein the first solid-state lighting chip, the second solid-state lighting chip, and the third solid-state lighting chip are solid-state lighting chip with the same color light, at least two of the first filling layer, the second filling layer, and the third filling layer including two different phosphor materials respectively doped therein, thus light emitting from the first filling layer, the second filling layer, and the third filling layer being mixed and appearing to be white light.

2. The solid-state illuminating apparatus as claimed in claim 1, wherein the first solid-state lighting chip, the second solid-state lighting chip, and the third solid-state lighting chip are GaN LED chips or AlGaN LED chips.

3. The solid-state illuminating apparatus as claimed in claim 1, wherein the first solid-state lighting chip, the second solid-state lighting chip, and the third solid-state lighting chip are blue LED chip, the phosphor material in the first filling layer is red phosphor, and the phosphor material in the second filling layer is green phosphor or yellow phosphor.

4. The solid-state illuminating apparatus as claimed in claim 1, wherein the first solid-state lighting chip, the second solid-state lighting chip, and the third solid-state lighting chip are configured for emitting UV light, the phosphor material in the first filling layer is red phosphor, the phosphor material in the second filling layer is green phosphor or yellow phosphor, and the phosphor material in the third filling layer is blue phosphor.

5. The solid-state illuminating apparatus as claimed in claim 1, wherein the first solid-state lighting chip, the second solid-state lighting chip, and the third solid-state lighting chip each includes a separate driving circuit.

6. The solid-state illuminating apparatus as claimed in claim 1, further comprising a light scattering layer covering the first receiving groove, the second receiving groove and the third receiving groove, the light scattering layer having a plurality of scattering particles distributed therein.

7. The solid-state illuminating apparatus as claimed in claim 1, further comprising an optical microstructure layer covering the first receiving groove, the second receiving groove and the third receiving groove.

8. The solid-state illuminating apparatus as claimed in claim 7, further comprising a light scattering layer arranged between the optical microstructure layer and the first receiving groove, the second receiving groove, the third receiving groove, the light scattering layer having a plurality of scattering particles distributed therein.

9. The solid-state illuminating apparatus as claimed in claim 7, wherein the optical microstructure layer has a light emitting surface facing away from the first receiving groove, the second receiving groove and the third receiving groove, and the light emitting surface has a plurality of optical microstructures defined thereon.

10. The solid-state illuminating apparatus as claimed in claim 9, wherein the optical microstructures are elongated parallel prisms.

11. The solid-state illuminating apparatus as claimed in claim 9, wherein the optical microstructures are cone-shaped protrusions arranged in an array.

12. A solid-state illuminating apparatus comprising:
blue phosphor;
a first light emitting diode chip for emitting UV light to excite the blue phosphor to emit first light having a wavelength in the range from 445 nm to 475 nm;
a first driving circuit for independently driving the first light emitting diode chip to emit the UV light associated therewith;
green phosphor;
a second light emitting diode chip for emitting UV light to excite the green phosphor to emit a second light having a wavelength in the range from 505 nm to 540 nm;
a second driving circuit for independently driving the second light emitting diode chip to emit the UV light associated therewith;
red phosphor;
a third light emitting diode chip for emitting UV light to excite the red phosphor to emit a third light having a wavelength in the range from 610 nm to 645 nm; and
a third driving circuit for independently driving the third light emitting diode chip to emit the UV light, wherein the blue phosphor, green phosphor and red phosphor are in a manner such that the combined first, second and third light appears to be white light.

13. The solid-state illuminating apparatus as claimed in claim 12, wherein the first light emitting diode chip, the second light emitting diode chip, and the third light emitting diode chip are GaN LED chips or AlGaN LED chips.

14. The solid-state illuminating apparatus as claimed in claim 12, further comprising a light scattering layer covering the first, second and third light emitting diode chips, the light scattering layer having a plurality of scattering particles distributed therein.

15. The solid-state illuminating apparatus as claimed in claim 12, further comprising an optical microstructure layer covering the first, second and third light emitting diode chips.

16. The solid-state illuminating apparatus as claimed in claim 15, further comprising a light scattering layer arranged between the optical microstructure layer and the light emitting diode chips, the light scattering layer having a plurality of scattering particles distributed therein.

17. The solid-state illuminating apparatus as claimed in claim 15, wherein the optical microstructure layer has a light emitting surface facing away from the first, second and third light emitting diode chips, and the light emitting surface has a plurality of optical microstructures defined thereon.

18. The solid-state illuminating apparatus as claimed in claim 17, wherein the optical microstructures are elongated parallel prisms.

19. The solid-state illuminating apparatus as claimed in claim 17, wherein the optical microstructures are cone-shaped protrusions arranged in an array.
